(19) United States
(12) Patent Application Publication
(10) Pub. No.: US 2005/0066055 A1
(43) Pub. Date: Mar. 24, 2005

(54) Apparatus and method for configuring internet protocol address of host and service method using the internet protocol address

(75) Inventors: Soo-hong Park, Yongin-si (KR); Young-keun Kim, Incheon Maetropolitan-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/842,647

(22) Filed: May 11, 2004

(30) Foreign Application Priority Data
May 12, 2003 (KR) 2003-29756

(51) Int. Cl. G06F 15/16

(52) U.S. Cl. 709/245

(57) ABSTRACT

Provided are an apparatus and method for configuring a unicast address and a multicast address of a IPv6 host using local information and a service method using the unicast address and the multicast address of the IPv6 host that is configured using the local information. The service method includes: if a service provider desires unicasting service for a host located in a specific area, providing unicasting service to the host using local information allocated to the specific area; and if a service provider desires multicasting service for a plurality of hosts located in a specific area, providing multicasting service to the plurality of hosts using local information allocated to the specific area. Using the apparatus and method, it is possible for multicasting service providers in a IPv6-based network to effectively provide local service without using an additional inter-domain allocation protocol.

### CROSS REFERENCE TO RELATED APPLICATION

This application claims the priority of Korean Patent Application No. 2003-29756, filed on May 12, 2003, in the Korean Intellectual Property Office, the disclosure of which is hereby incorporated by reference in its entirety.

### BACKGROUND OF THE INVENTION

1. Field of the Invention

Apparatuses and methods consistent with the present invention relate to protocol address configuration in a network using an Internet protocol, and more particularly, to automatically configuring a unicast address and a multicast address of an Internet Protocol version 6 (hereinafter, referred to as IPv6) host in a IPv6-based network and a service method using the unicast address and the multicast address.

2. Description of the Related Art

IPv6 is an upgraded version of IPv4 and provides address auto-configuration function. An IPv6 host creates an interface identification (ID) using an allocated E.164 number through the address auto-configuration function. The E.164 number is a telephone number specified by International Telecommunication Union-Telecommunication Standardization Group (ITU-T) which has been used by existing telephone networks. The IPv6 host configures an IPv6 address using a network prefix of a local link and the interface ID.

The IPv6 address is a unicast address of the IPv6 host. The unicast address is used after being registered in a domain name service (hereinafter, referred to as DNS) server. As such, the conventional IPv6 host automatically configures only a unicast address using the allocated E.164 number, which limits application of the unicast address.

In addition, since the conventional IPv6 host automatically configures only a unicast address using the allocated E.164 number, an Internet service provider (ISP) must separately set addresses of IPv6 hosts that desire multicasting service and must use an additional inter-domain allocation protocol, so as to provide the IPv6 hosts with multicasting service.

### SUMMARY OF THE INVENTION

The present invention provides an apparatus for and method of automatically configuring a unicast address and a multicast address of an IPv6 host using local information.

The present invention also provides a service method using a unicast address and a multicast address of an IPv6 host, which are configured using local information.

According to an aspect of the present invention, there is provided an apparatus for configuring an Internet protocol address of a host, the apparatus comprising: a number detecting unit detecting a number including local information; and an address creating unit inserting the detected number into a field other than a prefix field and creating an Internet protocol address of the host.

According to another aspect of the present invention, there is provided a method of configuring an Internet protocol address of a host, the method comprising: detecting a number including local information;. and creating an Internet protocol address of the host by inserting the detected number into a field other than a prefix field.

According to another aspect of the present invention, there is provided a service method using an Internet protocol address created using a number including local information, the service method comprising: if a service provider desires unicasting service for a host located in a specific area, providing unicasting service to the host using local information allocated to the specific area; and if a service provider desires multicasting service for a plurality of hosts located in a specific area, providing multicasting service to the plurality of hosts using local information allocated to the specific area.

### BRIEF DESCRIPTION OF THE DRAWINGS

The above and other aspects and advantages of the present invention will become more apparent by describing in detail an exemplary embodiment thereof with reference to the attached drawings in which:

FIG. 1 is a functional block diagram of an apparatus for configuring an Internet protocol address according to the present invention;

FIG. 2A illustrates a format of a multicast address according to the present invention;

FIG. 2B illustrates a format of a unicast address according to the present invention;

FIG. 3 is a flowchart of a method of configuring an Internet protocol address according to the present invention; and

FIG. 4 illustrates a network employing a service method using an Internet protocol address created according to the present invention.

### DETAILED DESCRIPTION OF THE INVENTION

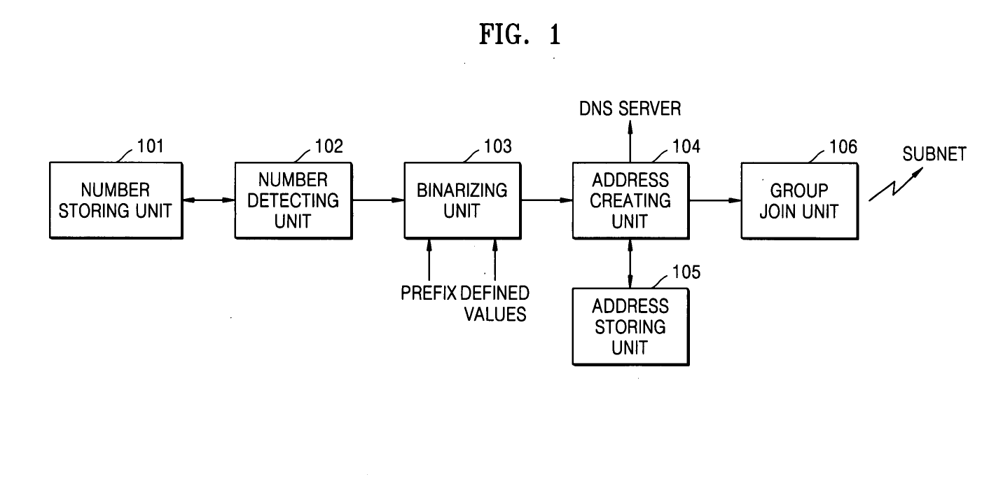

Referring to FIG. 1, an apparatus for configuring an Internet protocol address according to the present invention includes a number storing unit 101, a number detecting unit 102, a binarizing unit 103, an address creating unit 104, an address storing unit 105, and a group join unit 106.

The number storing unit 101 stores a number including local information such as a local telephone number or a zip code that identifies a location of a corresponding host and a private number allocated to the corresponding host. The number is previously stored. The number storing unit 101 may be a stack or a memory.

The number detecting unit 102 reads the number including the location information of the corresponding host which has been stored in the number storing unit 101. The number detecting unit 102 outputs the read number to the binarizing unit 103.

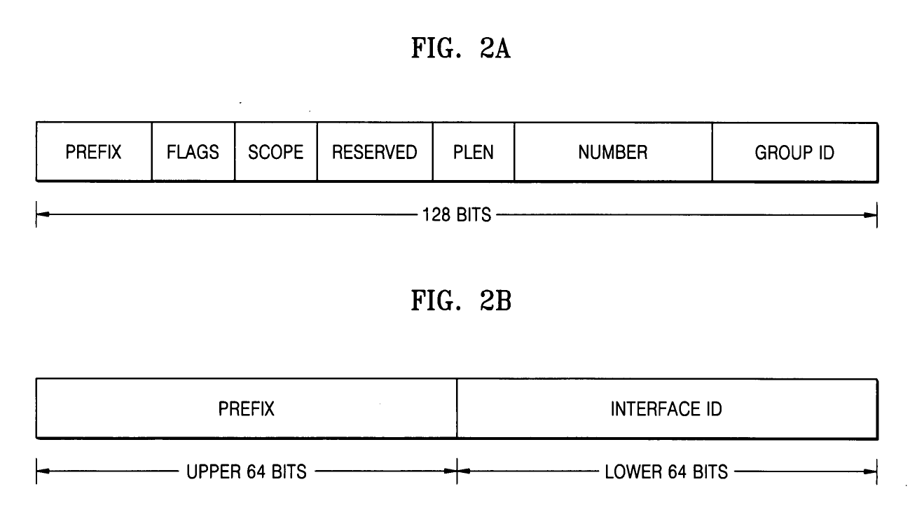

The binarizing unit 103 converts a prefix provided from a home agent (not shown) of a corresponding subnet, values defined when a multicast address is created, and the number including the location information output from the number detecting unit 102, into binaries of 4 bits. The prefix includes a network prefix needed for unicast address configuration and a prefix indicating a multicast address needed for multicast address configuration. The values defined when the multicast address is created may be values to be inserted into a FLAGS field, a SCOPE field, a PLEN field, and a group ID field, as shown in a format of a multicast address of FIG. 2A.

In the FLAGS field, a P bit and a T bit are set. The P bit must be set to “1” when the multicast address is created. The T bit is set to “1” when a multicast address known by the Ipv6 host is used, but, in other cases, the T bit may be set to “0”. In the SCOPE field, a bit is set to distinguish a case when a corresponding multicast address is a link-local from a case when the corresponding multicast address is global. In the PLEN field, a bit indicating a real size of the E.164 number is set. The values defined when the multicast address is created can be defined by a user of the IPv6 host.

The binarizing unit 103 outputs binarized values to the address creating unit 104. The address creating unit 104 automatically configures corresponding multicast address by inserting the read number into a field other than the prefix field indicating the multicast address and fields into which the values that are defined when the multicast address is created are inserted, as shown in FIG. 2A. That is, the address creating unit 104 creates the multicast address by combining the prefix field, the fields into which defined values are inserted, and the field into which the read number is inserted. In FIG. 2A, the depicted fields include a reserved field and a number field. The reserved field may be set to “0”. The number field may be configured by inserting bits of the binarized number corresponding to the read number after the upper 32 bits and padding “0s” or “1s” between an area of the inserted binarized number in the number field and the beginning of the group ID field. In contrast, the number field may be configured by sequentially inserting bits of the binarized number corresponding to the read number in the number field starting at the beginning of the group ID field and padding “0s” or “1s” between the last inserted bit of the binarized number and the last bit of the PLEN field.

The address creating unit 104 creates a unicast address as shown in FIG. 2B. FIG. 2B illustrates a format of a unicast address according to the present invention. As shown in FIG. 2B, the address creating unit 104 allocates the upper 64 bits of the unicast address to the prefix field and the lower 64 bits of the unicast address to the interface ID field. Thus, the binarized bits of the number including the local information sequentially fills a least significant bit (LSB) or a most significant bit (MSB) of the lower 64 bits of the unicast address. In the lower 64 bits, an area other than an area where the binarized bits of number is inserted is padded by “0s” or “1s”. Consequently, “0s” or “1s” may fill the interval between the prefix field and the area where the binarized bits of the number including the local information is inserted.

Once the unicast address is created, the address creating unit 104 registers the created unicast address in a domain name service (DNS) server (not shown) while storing the created unicast address in the address storing unit 105. Once the multicast address is created, the address creating unit 104 requests grouping for multicasting service of the group join unit 106 while storing the created multicast address in the address storing unit 105.

Thus, the group join unit 106 groups hosts having the same local information and/or the same group ID based on the created multicast address. For grouping, the group join unit 106 sends the group ID information and the local information to a subnet in which corresponding host exists. Then, the group join unit 106 sets corresponding host to multicasting service ready state.

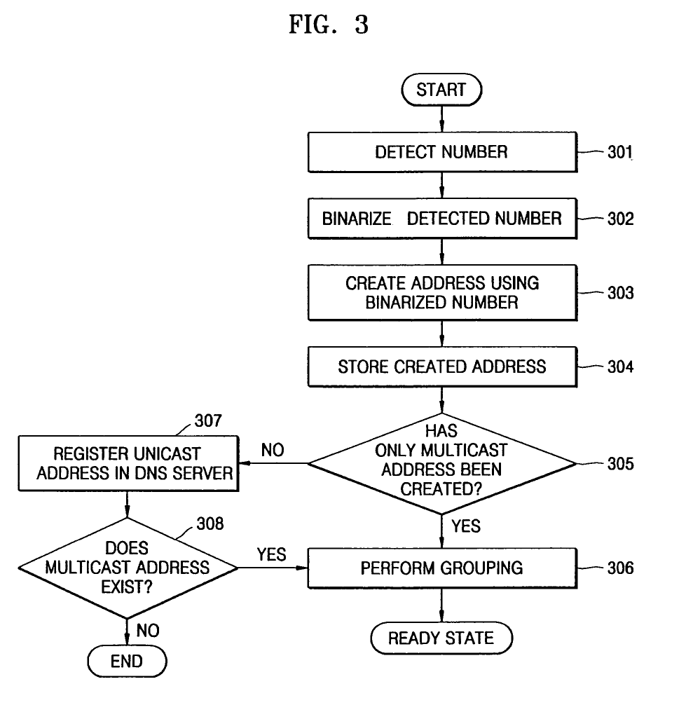

FIG. 3 is a flowchart illustrating a method of configuring an Internet protocol address according to the present invention.

Referring to FIG. 3, in operation 301, a corresponding IPv6 host number is detected. The IPv6 host number is a private number of the corresponding IPv6 host including local information. The IPv6 host number is previously set or stored in the corresponding IPv6 host.

In operation 302, the IPv6 host binarizes the detected IPv6 host number.

When a unicast address is created in operation 303, a binarized number corresponding to the detected IPv6 host number and a network prefix are combined to create a unicast address. Here, the binarized number is inserted into a field other than a field where the network prefix is inserted. In other words, the network prefix is inserted in the upper 64 bits of the unicast address, whereas the binarized number is inserted in the lower 64 bits of the unicast address.

When a multicast address is created in operation 303, the binarized number is inserted into a field other than the prefix field indicating the multicast address (for example, the prefix field is filled with “1s”) and fields where values that are defined when the multicast address is created are inserted. As is described above and in FIG. 2A, the binarized number may be inserted after the upper 32 bits.

Once the unicast address or/and the multicast address of the IPv6 host is/are automatically created, the created address is stored in the IPv6 host in operation 304.

In operation 305, it is checked if only the multicast address of the IPv6 host is created.

If only the multicast address is created, in operation 306, the IPv6 host is grouped with other hosts connected to the same subnet using local information and/or group ID information that are inserted into the created multicast address and is then set to a multicasting service ready state.

If only the multicast address is not created, in operation 307, the created unicast address is registered in a DNS server (not shown). In operation 308, it is checked if the multicast address is included in the created address. If the multicast address is included in the created address, a process of creating an address proceeds to operation 306. However, if the multicast address is not included in the created address, the process is completed.

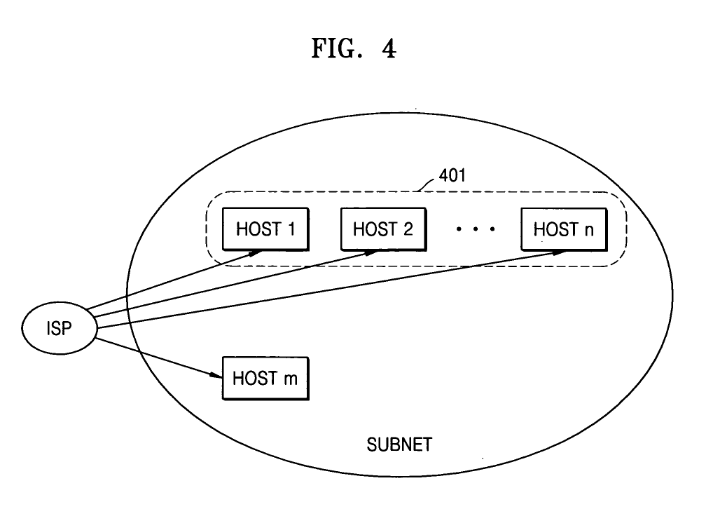

FIG. 4 illustrates a network adopting a service method using an Internet protocol address created according to the present invention.

In FIG. 4, a network configuration is illustrated for explaining a multicasting service of an Internet service provider (ISP) for a plurality of hosts Host 1-Host n included in one subnet and unicasting service of the ISP for host Host m.

The plurality of hosts Host 1-Host n creates a multicast address which has the same local information. Thus, the plurality of hosts Host 1-Host n is grouped as a group 401. Then, the ISP desires to provide multicasting service to the plurality of hosts Host 1-Host n of the group 401, the ISP provides multicasting service using local information and/or group identification (ID) information that are included in the multicast address created by the plurality of hosts Host 1-Host n of the group 401. In other words, the ISP sends a destination address of packets that are to be sent for multicasting service while including the local information and/or group ID information of the group 401 in the destination address. Thus, the plurality of hosts Host 1-Host n of the group 401 receives the packets.

The local information may be a local telephone number or zip code that identifies a location. The local telephone number may include a local identification number and a country identification number.

When the host Host m connected to the subnet automatically configures a unicast address having local information, the ISP uses the unicast address having the local information when providing unicasting service for the host Host m. The local information included in the unicast address may be a local telephone number or zip code that identifies a location.

As described above, according to the present invention, by automatically configuring a unicast address and a multicast address of an IPv6 host using local information (for example, a zip code or a local telephone number), it is possible for multicasting service providers in a IPv6-based network to effectively provide local service without using an additional inter-domain allocation protocol.

In addition, since IPv6 hosts that are provided with multicasting service can be grouped using group ID information and local information, it is possible to set subjects of multicasting service more variously.

Also, by configuring a unicast address including local information such as a local telephone number or zip code, application scope of the unicast address can be enlarged.

While the present invention has been particularly shown and described with reference to an exemplary embodiment thereof, it will be understood by those of ordinary skill in the art that various changes in form and details may be made therein without departing from the spirit and scope of the invention as defined by the appended claims and their equivalents.

1. An apparatus for configuring an Internet protocol address of a host, the apparatus comprising:
a number detecting unit detecting a number as a detected number, including local information; and
an address creating unit inserting the detected number into a first field other than a prefix field and creating an Internet protocol address of the host.

2. The apparatus of claim 1, wherein when the Internet protocol address is a multicast address, the address creating unit combines a prefix, the detected number, and values defined as defined values when the multicast address is created, wherein the first field is not the prefix field and not one of second fields in which the defined values are inserted.

3. The apparatus of claim 2, wherein the defined values include group identification (ID) information of the host.

4. The apparatus of claim 1, wherein the Internet protocol address includes a unicast address and a multicast address of the host.

5. The apparatus of claim 1, wherein the local information is either a local telephone number or a zip code, wherein the local telephone number or the zip code identifies a location where the host exists.

6. The apparatus of claim 1, further comprising a binarizing unit binarizing the detected number as a binarized number and providing the binarized number to the address creating unit.

7. The apparatus of claim 1, further comprising a group join unit if the Internet protocol address is a multicast address, performing grouping with one or more other hosts using the multicast address.

8. The apparatus of claim 1, wherein, if the Internet protocol address is a unicast address including the local information, the address creating unit registers the unicast address in a domain name service server.

9. A method of configuring an Internet protocol address of a host, the method comprising:
detecting a number including local information as a detected number; and
creating an Internet protocol address of the host by inserting the detected number into a first field other than a prefix field.

10. The method of claim 9, wherein, if the Internet protocol address is a multicast address, the first field is not the prefix field and not one of second fields wherein inserted values are defined when the multicast address is created.

11. The method of claim 10, wherein the defined values include group identification (ID) information of the host.

12. The method of claim 9, wherein the creation of the Internet protocol address includes creating the unicast address and the multicast address of the host.

13. The method of claim 9, further comprising binarizing the detected number.

14. The method of claim 9, further comprising, if the Internet protocol address is a multicast address, performing grouping with one or more other hosts using the multicast address.

15. A service method using an Internet protocol address created using a number including local information, the service method comprising:
if a service provider desires unicasting service for a host located in a first specific area, providing unicasting service to the host using first local information allocated to the first specific area; and
if a service provider desires multicating service for a plurality of hosts located in a second specific area, providing multicasting service to the plurality of hosts using second local information allocated to the second specific area.

16. The service method of claim 14, wherein if the Internet protocol address is a multicast address including group identification (ID) information, the providing of multicasting service includes considering at least one of the local information and the group ID information.

17. The service method of claim 14, wherein the providing of multicasting service and the providing of unicasting service are performed by considering the local information, wherein the local information comprises a telephone number or a zip code, wherein the telephone number or the zip code identifies a location where the host exists.
